(19) United States
(12) Patent Application Publication
(10) Pub. No.: US 2021/0362991 A1
(43) Pub. Date: Nov. 25, 2021

(54) TRANSPORTATION DEVICE

(71) Applicant: WUHAN CHINA STAR OPTOELECTRONICS SEMICONDUCTOR DISPLAY TECHNOLOGY CO., LTD., Wuhan, Hubei (CN)

(72) Inventors: Kai WAN, Wuhan, Hubei (CN); Tianyu ZHANG, Wuhan, Hubei (CN); Yong WANG, Wuhan, Hubei (CN)

(21) Appl. No.: 16/605,049

(22) PCT Filed: May 17, 2019
(86) PCT No.: PCT/CN2019/087393

§ 371 Date: Oct. 14, 2019

(30) Foreign Application Priority Data
Jan. 31, 2019 (CN) 201910099994.X

(51) Int. Cl. B66F 9/12; B66C 1/32

(52) U.S. Cl. CPC B66F 9/122; B66C 1/32

(57) ABSTRACT

A transportation device for liquid crystal panel, wherein the transportation device comprises a housing, a bottom of the housing is provided with moving wheels, a first support portion, a second support portion, and a lifting platform supporting the second support portion. The first support portion is configured to cooperate with a first grab device, the second support portion is configured to cooperate with a second grab device.

### BACKGROUND OF INVENTION

### Field of Invention

The present invention relates to the field of display technologies, and in particular, to a transportation device for liquid crystal panel.

### Description of Prior Art

As the degree of automation in the field of electronic displays continues to increase, panel transportation methods in production lines have been gradually upgraded from manual guided vehicles (MGV) to overhead hoist transfer (OHT) and auto-guided vehicles (AGV).

### Technical Problem

OTH uses claw-type grabbing to achieve material loading, while AGV uses fork-shaped pallets to achieve material loading. Their transportation methods are different, so the interfaces to which they are docked also different. Therefore, if the transportation method needs to be replaced, the corresponding interface also needs to be replaced, thereby limiting the selection of the transportation methods in the production lines.

### SUMMARY OF INVENTION

The present invention provides a transportation device for liquid crystal panel, the device can be used in various transportation methods of liquid crystal panel.

In order to solve the above problems, the present invention provides a transportation device for liquid crystal panel, wherein the transportation device comprises a housing, a first support portion at a top of the housing, a second support portion located in a cavity of the housing, and a lifting platform supporting the second support portion;

wherein a bottom of the housing is provided with moving wheels;

wherein the first support portion is configured to cooperate with a first grab device, a top of the first support portion is higher than the top of the housing when the liquid crystal panel is transferred between the transportation device and the first grab device, and a distance from the top of the first support portion to the top of the housing is greater than or equal to a thickness of a grab component of the first grab device;

wherein the second support portion is configured to cooperate with a second grab device, a top of the second support portion is lower than a bottom of the liquid crystal panel when the liquid crystal panel is transferred between the transportation device and the first grab device, and a top of the second support portion is higher than the top of the first support portion when the liquid crystal panel is transferred between the transfer device and the second grab device; and

wherein a projection of the second support portion on the horizontal plane separates from a projection of the first support portion on the horizontal plane.

According to one aspect of the invention, wherein the first grab device is a bottom-inserting device, the bottom-inserting device has a fork-shaped component capable of lifting the liquid crystal panel from the bottom of the liquid crystal panel;

wherein the second grab device is a top-grabbing device, the top-grabbing device has a claw-shaped component capable of grabbing the liquid crystal panel from a top of the liquid crystal panel.

According to one aspect of the invention, wherein the first support portion comprises a left support portion and a right support portion disposed in parallel, a projection of the second support portion on the horizontal plane is between a projection of the left support portion and a projection of the right support portion on the horizontal plane;

wherein a distance between the left support portion and the right support portion is greater than a maximum width of the second support portion.

According to one aspect of the invention, wherein when the liquid crystal panel is transferred between the transportation device and the first grab device, the lifting platform is at a minimum height, and wherein when the liquid crystal panel is transferred between the transfer device and the second grab device, the lifting platform is at a maximum height.

According to one aspect of the invention, wherein the top of the second support is lower than the top of the housing when the lifting platform is at the minimum height.

According to one aspect of the invention, wherein the top of the second support portion and the bottom of the first support portion are on a same plane when the lifting platform is at the minimum height.

According to one aspect of the invention, wherein a horizontal distance between a left side of the second support portion and the left support portion is smaller than a width of a left branch of the fork-shaped component, and a horizontal distance between a right side of the second support portion and the right support portion is smaller than a width of a right branch of the fork-shaped component.

According to one aspect of the invention, The transportation device for liquid crystal panel according to claim 4, wherein a distance between the top of the second support portion and the top of the first support portion is greater than a thickness of a horizontal portion of the claw-shaped component when the lifting platform is at the maximum height.

According to one aspect of the invention, wherein a distance between the top of the second support portion and the top of the first support portion is greater than twice of a thickness of a horizontal portion of the claw-shaped component when the lifting platform is at the maximum height.

The present invention further provides a transportation device for liquid crystal panel, wherein the transportation device comprises a housing, a first support portion at a top of the housing, a second support portion located in a cavity of the housing, and a lifting platform supporting the second support portion;

wherein a bottom of the housing is provided with moving wheels;

wherein the first support portion is configured to cooperate with a first grab device, a top of the first support portion is higher than the top of the housing when the liquid crystal panel is transferred between the transportation device and the first grab device, and a distance from the top of the first support portion to the top of the housing is greater than or equal to a thickness of a grab component of the first grab device;

wherein the second support portion is configured to cooperate with a second grab device, a top of the second support portion is lower than a bottom of the liquid crystal panels when the liquid crystal panel is transferred between the transportation device and the first grab device, and a top of the second support portion is higher than the top of the first support portion when the liquid crystal panel is transferred between the transfer device and the second grab device.

According to one aspect of the invention, wherein a projection of the second support portion on the horizontal plane separates from a projection of the first support portion on the horizontal plane.

According to one aspect of the invention, wherein the first grab device is a bottom-inserting device, the bottom-inserting device has a fork-shaped component capable of lifting the liquid crystal panel from the bottom of the liquid crystal panel;

wherein the second grab device is a top-grabbing device, the top-grabbing device has a claw-shaped component capable of grabbing the liquid crystal panel from a top of the liquid crystal panel.

According to one aspect of the invention, wherein the first support portion comprises a left support portion and a right support portion disposed in parallel, a projection of the second support portion on the horizontal plane is between a projection of the left support portion and a projection of the right support portion on the horizontal plane;

wherein a distance between the left support portion and the right support portion is greater than a maximum width of the second support portion.

According to one aspect of the invention, wherein when the liquid crystal panel is transferred between the transportation device and the first grab device, the lifting platform is at a minimum height, and wherein when the liquid crystal panel is transferred between the transfer device and the second grab device, the lifting platform is at a maximum height.

According to one aspect of the invention, wherein the top of the second support is lower than the top of the housing when the lifting platform is at the minimum height.

According to one aspect of the invention, wherein the top of the second support portion and the bottom of the first support portion are on a same plane when the lifting platform is at the minimum height.

According to one aspect of the invention, wherein a horizontal distance between a left side of the second support portion and the left support portion is smaller than a width of a left branch of the fork-shaped component, and a horizontal distance between a right side of the second support portion and the right support portion is smaller than a width of a right branch of the fork-shaped component.

According to one aspect of the invention, wherein a distance between the top of the second support portion and the top of the first support portion is greater than a thickness of a horizontal portion of the claw-shaped component when the lifting platform is at the maximum height.

According to one aspect of the invention, wherein a distance between the top of the second support portion and the top of the first support portion is greater than twice of a thickness of a horizontal portion of the claw-shaped component when the lifting platform is at the maximum height.

### Beneficial Effects

The transportation device of liquid crystal panel of the present invention has a first support portion that cooperates with a bottom insertion device and a second transmission portion that cooperates with a top grabbing device. Therefore, the present application can be applied to different types of liquid crystal panel loading devices, whether it is a manual guided vehicle or an automated guided vehicle, which can be used in conjunction with the transportation device of the present invention. Compared with transportation devices in the prior art, the present invention increases the flexibility of the liquid crystal panel transportation, breaking the limitation of the docking type to the selection of the loading device.

### BRIEF DESCRIPTION OF DRAWINGS

FIG. 1 is an overall structural diagram of a manual guided vehicle (MGV).

FIG. 2 is a structural diagram of a transportation device of the MGV of FIG. 1.

FIG. 3 is a front view of FIG. 2.

FIG. 4 is a structural diagram of an overhead hoist transfer (OHT) according to an embodiment of the present invention.

FIG. 5 is a front elevational view of FIG. 4.

FIG. 6 and FIG. 7 are structural diagrams of a transportation device of a liquid crystal panel according to the present invention.

FIG. 8 and FIG. 9 are structural diagrams of a transportation device of liquid crystal panel in practical use according to the present invention.

### DETAILED DESCRIPTION OF PREFERRED EMBODIMENTS

Description of following embodiment, with reference to accompanying drawings, is used to exemplify specific embodiments which may be carried out in the present disclosure. Directional terms mentioned in the present disclosure, such as “top”, “bottom”, “front”, “back”, “left”, “right”, “inside”, “outside”, “side”, etc., are only used with reference to orientation of the accompanying drawings. Therefore, the directional terms are intended to illustrate, but not to limit, the present disclosure. In the drawings, components having similar structures are denoted by same numerals.

First, the prior art will be briefly described.

The existing liquid crystal panel loading equipment mainly include manual guided vehicles (MGV), overhead hoist transfer (OHT) and auto-guided vehicles (AGV).

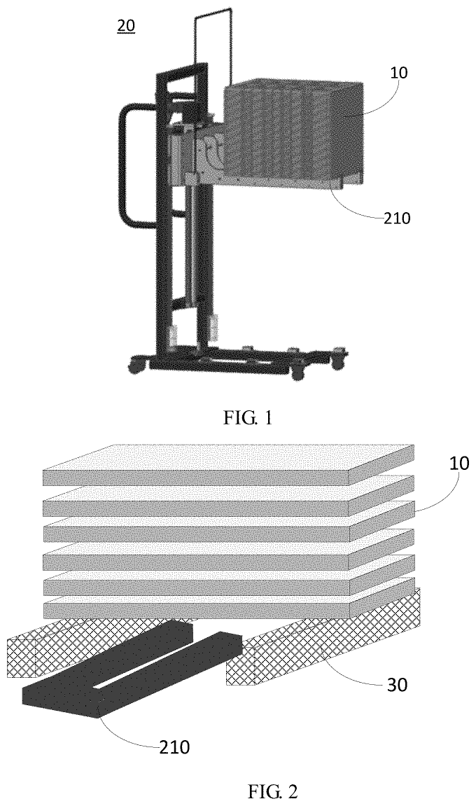

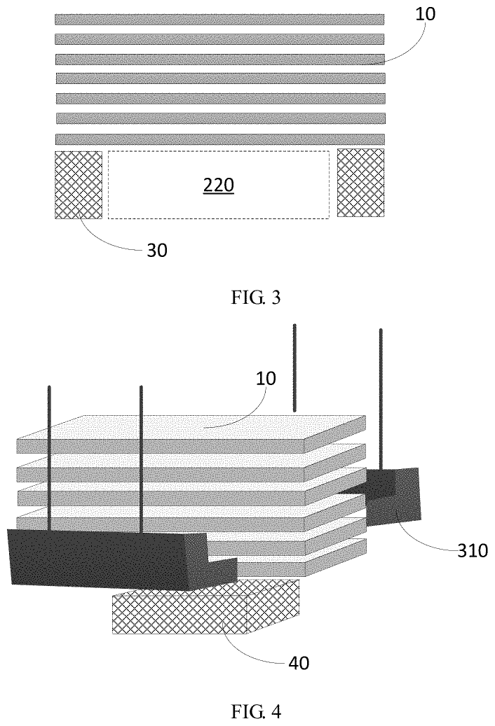

As shown in FIG. 1 to FIG. 3, FIG. 1 is an overall structural diagram of a MGV, FIG. 2 is a structural diagram of a transportation device of the MGV of FIG. 1, FIG. 3 is a front view of FIG. 2. The MGV 20 includes a fork-shaped grabbing member 210, and a transport device 30 matched with the first liquid crystal panel of the MGV 20 is two strip-shaped support structures disposed in parallel. When the liquid crystal panel 10 is transferred between the MGV 20 and the first liquid crystal panel transport device 30, support frames extend into a gap 220 between the two strip-shaped support structures and then lift upward. The liquid crystal panel 10 is transferred to the fork-shaped grabbing member 210 of the MGV 20.

It can be seen that the transport device 30 matched with the first liquid crystal panel of the MGV 20 must have two support structures arranged in parallel to facilitate mating with the fork-shaped grabbing member 210 of the MGV 20.

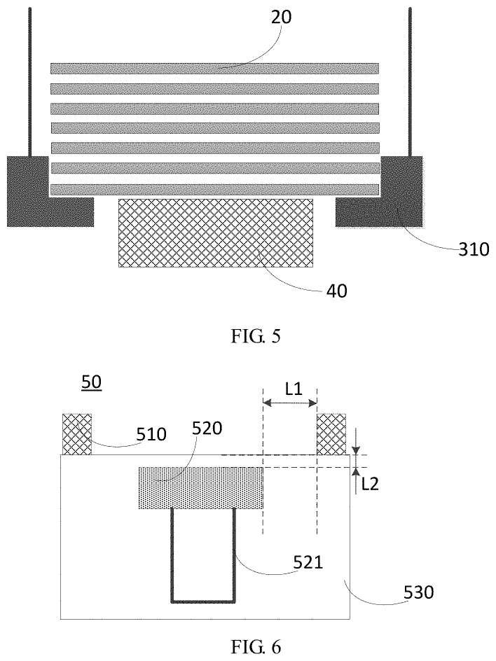

FIG. 4 is a structural diagram of an overhead hoist transfer (OHT) according to an embodiment of the present invention, FIG. 5 is a front elevational view of FIG. 4. The OHT includes a claw-shaped lifting member 310. A transportation device 40 matched with the second liquid crystal panel of the OHT is a support platform. The maximum width of a projection of the support platform on a horizontal plane in a horizontal direction is smaller than a projection width of the liquid crystal panel 10 on the horizontal plane, so that the claw-shaped lifting member 310 is fastened to a bottom of the liquid crystal panel 10 to lift the liquid crystal panel 10.

It can be seen that the transport device 40 matched with the second liquid crystal panel of the OHT must have a support platform that is wider than the liquid crystal panel to facilitate mating with the claw-shaped lifting member 310 of the OHT.

That is, in the prior art, the transportation equipment of the liquid crystal panel matched with different transportation devices are also different. If the liquid crystal panel loading device needs to be replaced, the corresponding transportation device needs to be replaced at the same time, and the replacement cost is high.

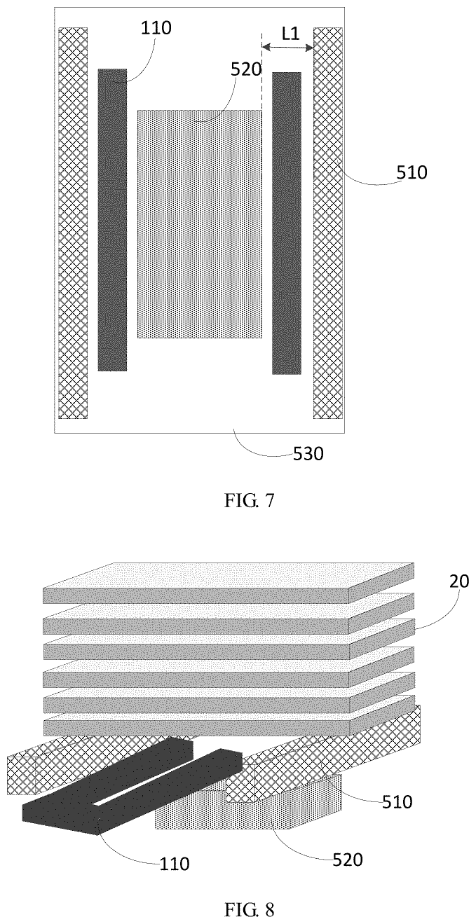

In order to solve the above problems, the present invention provides a transportation device for liquid crystal panel, the device can be used in various transportation methods of liquid crystal panel. As shown in FIG. 6 and FIG. 7, FIG. 6 and FIG. 7 are structural diagrams of a transportation device of a liquid crystal panel according to the present invention. The transportation device 50 comprises a housing 530, a first support portion 510 at a top of the housing 530, a second support portion 520 located in a cavity of the housing 530, and a lifting platform 521 supporting the second support portion 520.

Preferably, in the present embodiment, a bottom of the housing 530 has moving wheels (not shown) to facilitate the movement of the transportation device 50 according to a preset trajectory.

The first support portion 510 is configured to cooperate with a first grab device, a top of the first support portion 510 is higher than the top of the housing 530 when the liquid crystal panel is transferred between the transportation device and the first grab device, and a distance from the top of the first support portion 510 to the top of the housing 530 is greater than or equal to a thickness of a grab component of the first grab device.

The second support portion 520 is configured to cooperate with a second grab device, a top of the second support portion 520 is lower than a bottom of the liquid crystal panel when the liquid crystal panel is transferred between the transportation device and the first grab device, and a top of the second support portion 520 is higher than the top of the first support portion 510 when the liquid crystal panel is transferred between the transfer device and the second grab device.

Preferably, in the present embodiment, the first grab device is a bottom-inserting device, the bottom-inserting device has a fork-shaped component capable of lifting the liquid crystal panel from the bottom of the liquid crystal panel. The second grab device is a top-grabbing device, the top-grabbing device has a claw-shaped component capable of grabbing the liquid crystal panel from a top of the liquid crystal panel.

In the present embodiment, a projection of the second support portion 520 on the horizontal plane separates from a projection of the first support portion 510 on the horizontal plane.

In the present embodiment, the first support portion 510 comprises a left support portion and a right support portion disposed in parallel, a projection of the second support portion 520 on the horizontal plane is between a projection of the left support portion and a projection of the right support portion on the horizontal plane. A distance between the left support portion and the right support portion is greater than a maximum width of the second support portion 520.

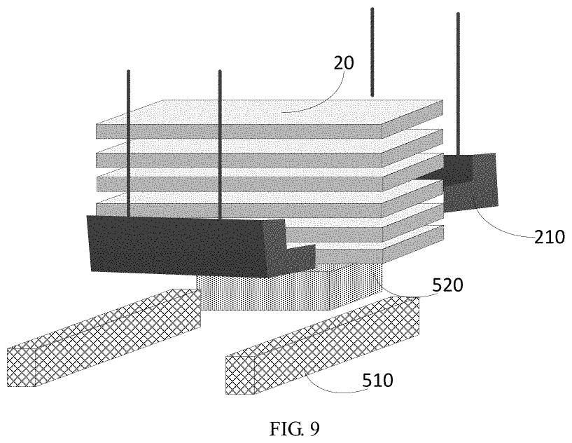

The application scenario of the transportation device in the present invention will be described in detail below with reference to specific embodiments. FIG. 8 and FIG. 9 are structural diagrams of a transportation device of liquid crystal panel in practical use according to the present invention.

As shown in FIG. 8, when the liquid crystal panel 20 is transferred between the transportation device 50 and the first grab device, the lifting platform 521 is at a minimum height. That is, the top of the second support portion 520 is lower than the top of the housing 530 when the lifting platform is at the minimum height. In other embodiments, the top of the second support portion 520 and the bottom of the first support portion 510 are on a same plane when the lifting platform is at the minimum height, or the top of the second support portion 520 is lower than the bottom of the first support portion 510. This arrangement facilitates the engagement of the transport device 50 with the fork-shaped grabbing member 110 of the first grab device such that the fork-shaped grabbing member 110 can be unimpeded into a bottom of the liquid crystal panel 20. Generally, a thickness of the fork-shaped grabbing member 110 is smaller than a thickness of the first support portion 510.

As shown in FIG. 9, when the liquid crystal panel 20 is transferred between the transfer device 50 and the second grab device, the lifting platform is at a maximum height. That is, a distance between the top of the second support portion 520 and the top of the first support portion 510 is greater than a thickness of a horizontal portion of the claw-shaped component when the lifting platform is at the maximum height. Preferably, a distance between the top of the second support portion 520 and the top of the first support portion 510 is greater than twice of a thickness of a horizontal portion of the claw-shaped component when the lifting platform is at the maximum height. This arrangement facilitates the engagement of the transportation device 50 with a claw-shaped lifting member 210 of the second lift device, so that the claw-shaped lifting member 210 can be accurately snapped under a bottom of the liquid crystal panel 20.

Preferably, a horizontal distance between a left side of the second support portion 520 and the left support portion is smaller than a width of a left branch of the fork-shaped component, and a horizontal distance between a right side of the second support portion 520 and the right support portion is smaller than a width of a right branch of the fork-shaped component.

The transportation device of liquid crystal panel of the present invention has a first support portion that cooperates with a bottom insertion device and a second transmission portion that cooperates with a top grabbing device. Therefore, the present application can be applied to different types of liquid crystal panel loading devices, whether it is a manual guided vehicle or an automated guided vehicle, which can be used in conjunction with the transportation device of the present invention. Compared with transportation devices in the prior art, the present invention increases the flexibility of the liquid crystal panel transportation, breaking the limitation of the docking type to the selection of the loading device.

As is understood by persons skilled in the art, the foregoing preferred embodiments of the present disclosure are illustrative rather than limiting of the present disclosure. It is intended that they cover various modifications and that similar arrangements be included in the spirit and scope of the present disclosure, the scope of which should be accorded the broadest interpretation so as to encompass all such modifications and similar structures.

What is claimed is:

1. A transportation device for liquid crystal panel, wherein the transportation device comprises a housing, a first support portion at a top of the housing, a second support portion located in a cavity of the housing, and a lifting platform supporting the second support portion;
wherein a bottom of the housing is provided with moving wheels;
wherein the first support portion is configured to cooperate with a first grab device, a top of the first support portion is higher than the top of the housing when the liquid crystal panel is transferred between the transportation device and the first grab device, and a distance from the top of the first support portion to the top of the housing is greater than or equal to a thickness of a grab component of the first grab device;
wherein the second support portion is configured to cooperate with a second grab device, a top of the second support portion is lower than a bottom of the liquid crystal panel when the liquid crystal panel is transferred between the transportation device and the first grab device, and a top of the second support portion is higher than the top of the first support portion when the liquid crystal panel is transferred between the transfer device and the second grab device; and
wherein a projection of the second support portion on the horizontal plane separates from a projection of the first support portion on the horizontal plane.

2. The transportation device for liquid crystal panel according to claim 1, wherein the first grab device is a bottom-inserting device, the bottom-inserting device has a fork-shaped component capable of lifting the liquid crystal panel from the bottom of the liquid crystal panel;
wherein the second grab device is a top-grabbing device, the top-grabbing device has a claw-shaped component capable of grabbing the liquid crystal panel from a top of the liquid crystal panel.

3. The transportation device for liquid crystal panel according to claim 2, wherein the first support portion comprises a left support portion and a right support portion disposed in parallel, a projection of the second support portion on the horizontal plane is between a projection of the left support portion and a projection of the right support portion on the horizontal plane;
wherein a distance between the left support portion and the right support portion is greater than a maximum width of the second support portion.

4. The transportation device for liquid crystal panel according to claim 3, wherein when the liquid crystal panel is transferred between the transportation device and the first grab device, the lifting platform is at a minimum height, and wherein when the liquid crystal panel is transferred between the transfer device and the second grab device, the lifting platform is at a maximum height.

5. The transportation device for liquid crystal panel according to claim 4, wherein the top of the second support portion is lower than the top of the housing when the lifting platform is at the minimum height.

6. The transportation device for liquid crystal panel according to claim 4, wherein the top of the second support portion and the bottom of the first support portion are on a same plane when the lifting platform is at the minimum height.

7. The transportation device for liquid crystal panel according to claim 5, wherein a horizontal distance between a left side of the second support portion and the left support portion is smaller than a width of a left branch of the fork-shaped component, and a horizontal distance between a right side of the second support portion and the right support portion is smaller than a width of a right branch of the fork-shaped component.

8. The transportation device for liquid crystal panel according to claim 4, wherein a distance between the top of the second support portion and the top of the first support portion is greater than a thickness of a horizontal portion of the claw-shaped component when the lifting platform is at the maximum height.

9. The transportation device for liquid crystal panel according to claim 8, wherein a distance between the top of the second support portion and the top of the first support portion is greater than twice of a thickness of a horizontal portion of the claw-shaped component when the lifting platform is at the maximum height.

10. A transportation device for liquid crystal panel, wherein the transportation device comprises a housing, a first support portion at a top of the housing, a second support portion located in a cavity of the housing, and a lifting platform supporting the second support portion;
wherein a bottom of the housing is provided with moving wheels;
wherein the first support portion is configured to cooperate with a first grab device, a top of the first support portion is higher than the top of the housing when the liquid crystal panel is transferred between the transportation device and the first grab device, and a distance from the top of the first support portion to the top of the housing is greater than or equal to a thickness of a grab component of the first grab device;
wherein the second support portion is configured to cooperate with a second grab device, a top of the second support portion is lower than a bottom of the liquid crystal panels when the liquid crystal panel is transferred between the transportation device and the first grab device, and a top of the second support portion is higher than the top of the first support portion when the liquid crystal panel is transferred between the transfer device and the second grab device.

11. The transportation device for liquid crystal panels according to claim 10, wherein a projection of the second support portion on the horizontal plane separates from a projection of the first support portion on the horizontal plane.

12. The transportation device for liquid crystal panels according to claim 10, wherein the first grab device is a bottom-inserting device, the bottom-inserting device has a fork-shaped component capable of lifting the liquid crystal panel from the bottom of the liquid crystal panel;
wherein the second grab device is a top-grabbing device, the top-grabbing device has a claw-shaped component capable of grabbing the liquid crystal panel from a top of the liquid crystal panel.

13. The transportation device for liquid crystal panels according to claim 12, wherein the first support portion comprises a left support portion and a right support portion disposed in parallel, a projection of the second support portion on the horizontal plane is between a projection of the left support portion and a projection of the right support portion on the horizontal plane;
wherein a distance between the left support portion and the right support portion is greater than a maximum width of the second support portion.

14. The transportation device for liquid crystal panels according to claim 13, wherein when the liquid crystal panel is transferred between the transportation device and the first grab device, the lifting platform is at a minimum height, and wherein when the liquid crystal panel is transferred between the transfer device and the second grab device, the lifting platform is at a maximum height.

15. The transportation device for liquid crystal panels according to claim 14, wherein the top of the second support portion is lower than the top of the housing when the lifting platform is at the minimum height.

16. The transportation device for liquid crystal panels according to claim 14, wherein the top of the second support portion and the bottom of the first support portion are on a same plane when the lifting platform is at the minimum height.

17. The transportation device for liquid crystal panels according to claim 15, wherein a horizontal distance between a left side of the second support portion and the left support portion is smaller than a width of a left branch of the fork-shaped component, and a horizontal distance between a right side of the second support portion and the right support portion is smaller than a width of a right branch of the fork-shaped component.

18. The transportation device for liquid crystal panels according to claim 14, wherein a distance between the top of the second support portion and the top of the first support portion is greater than a thickness of a horizontal portion of the claw-shaped component when the lifting platform is at the maximum height.

19. The transportation device for liquid crystal panels according to claim 18, wherein a distance between the top of the second support portion and the top of the first support portion is greater than twice of a thickness of a horizontal portion of the claw-shaped component when the lifting platform is at the maximum height.
